(19) United States
(12) Patent Application Publication
(10) Pub. No.: US 2019/0272525 A1
(43) Pub. Date: Sep. 5, 2019

(54) CARD-LESS PAYMENT SYSTEM, PROGRAM THEREFOR, AND CARD-LESS PAYMENT METHOD FOR VARIOUS TYPES OF MULTIPLE BUSINESS PERSONS

(71) Applicant: Kazuto NAKAMURA, Osaka (JP)

(72) Inventor: Kazuto NAKAMURA, Osaka (JP)

(21) Appl. No.: 16/287,819

(22) Filed: Feb. 27, 2019

(30) Foreign Application Priority Data
Mar. 2, 2018 (JP) 2018-37837

(51) Int. Cl. G06Q 20/32; G06Q 20/14

(52) U.S. Cl. CPC G06Q 20/325; G06Q 20/14; G06Q 20/3224

(57) ABSTRACT

A card-less payment system is introduced by business persons moving and selling goods, without the cost of a credit card payment terminal or special device. In the system, customer card information is sent in advance to an operator server, which adds a card processing ID to the customer card information and registers them in an intermediary server. Then the business person enters the amount and the telephone number of a customer terminal into a business terminal and sends them to the operator server, which sends approval information to the customer terminal. After the customer approves the information, a payment request is sent to the intermediary server, which replaces the card processing ID with the customer card information, and sends the card information to a card company server. After payment, a result from the server is sent to the operator server, and to the business and customer terminals.

This application claims the benefit of Japanese Patent Application No. 2018-37837, filed Mar. 2, 2018, which is incorporated herein by reference in its entirety.

### BACKGROUND OF THE INVENTION

The present invention relates to a card-less payment system, a program therefor, and a card-less payment method for various types of multiple business persons.

As a conventional card-less payment system (credit card payment system in a broad sense), for example, a system capable of paying taxi fee with card-less, in a taxi vehicle having no on-vehicle credit card settlement terminal, is known (for example, Japanese Unexamined Publication No. 2014-115780).

In the above card-less payment system, when a passenger having a terminal thereof reserves a taxi dispatch with intension of card-less payment using the terminal, information on credit card of the passenger is transmitted to the card payment center and then an authorization processing is executed, and if the authorization processing result is affirmative, the dispatch reservation from the passenger terminal is accepted.

However, in the above-mentioned card-less payment system, the card-less payment is possible only in the case that the taxi dispatch is made by reservation, but if the dispatch reservation is not used, since the above credit processing is not performed, the card-less payment is not possible. Also, in the above-mentioned system, a relatively expensive on-vehicle radio terminal connected to a taxi radio network is indispensable, and if such an on-vehicle radio terminal is not installed, this payment system can not be used.

In addition, since the above-mentioned card-less payment system has the above-mentioned problems, even in business other than taxis, it is not easy to apply the system to a plurality of different businesses, for example, a retail business delivering goods to customers for payment on delivery. Particularly, in the case of mobile sales operators of individuals or micro enterprises, it is desired to realize an inexpensive system for enabling payment processing without cards and without cash, without increasing the cost of introducing equipment. In addition, when electronic money is used with a smart phone as a customer terminal, for example, it is necessary to charge money in advance, namely in prepaid. Credit card payment is desirable, which is not prepaid (payment may be postponed by the credit card payment settlement, that is, postpaid).

It is an object of the present invention to solve the above problem, and the present invention aims to provide a card-less payment system, a program for the card-less payment system, and a card-less payment method, which can be easily introduced to achieve card-less payment without necessity of a credit card settlement terminal and without special cost for introducing equipment, and which can be used by various types of multiple businesses who sell goods or services while moving including the taxi industry. And, when it is applied to the taxi industry, even if a customer is on board without making the taxi dispatch reservation, or even a taxi that does not have an on-vehicle radio terminal connected to a taxi radio network, the card-less payment can easily be carried out.

### SUMMARY OF THE INVENTION

In order to attain the above-mentioned subject, the card-less payment system of the present invention comprises:

a customer terminal owned by a customer and connectable to a network;

a business terminal used for card payment processing by a business person of various types and connectable to the network;

an operator server for operating and managing the system with a business application and a customer application which are used for the card payment processing by the business person and the customer, respectively;

a card company server for performing the card payment processing; and

a intermediary server for performing processing between the customer terminal and the card company server and also between the operator server and the card company server, wherein

the customer application is in advance downloaded from the operator server to the customer terminal and, when customer card information is entered into the customer terminal and transmitted to the operator server, the operator server adds a card processing ID to the customer card information and registers them in the intermediary server,

the business application is in advance downloaded from the operator server to the business terminal and,

when the customer having the customer terminal wants to perform card payment using the customer application for cost of the goods or services provided by the business person, a payment request is made by the business person by entering payment amount and telephone number of the customer terminal into the business terminal and transmitting them to the operator server using the business application,

the operator server transmits approval information including the card processing ID and the payment amount to the customer terminal in response to the payment request from the business terminal,

when it is judged by the customer that there is no mistake in the approval information transmitted from the operator server, a payment request is made by the customer by transmitting the card processing ID and the payment amount from the customer terminal to the intermediary server,

the intermediary server, upon receiving the payment request from the customer terminal, makes a payment request to the card company server after replacing the card processing ID with the customer card information, receives a payment result transmitted from the card company server, and notifies the payment result to the operator server,

the operator server transmits the notified payment result to the business terminal and the customer terminal.

According to the present invention, the card-less payment can be introduced easily among various types of multiple moving business persons by using a mobile terminal such as a smartphone or a tablet terminal without any credit card settlement terminal and any cost for introducing special devices. In addition, when it is applied to a taxi industry, even if a customer is on board without making the taxi dispatch reservation for which a card-less settlement was requested in advance, or even a taxi that does not have any on-vehicle terminal connectable to a taxi wireless network, the card-less payment can easily be carried out.

### BRIEF DESCRIPTION OF THE DRAWINGS

FIG. 1 is a configuration diagram of a card-less payment system according to an embodiment of the present invention.

FIG. 2 is a diagram showing a data flow between a customer terminal, an operator server and an intermediary server after acquiring a customer application in the card-less payment system.

FIG. 3 is a diagram showing a data flow of a card payment processing in the card-less payment system.

FIG. 4 is a diagram showing a data flow of card payment notification in the card-less payment system.

FIG. 5 is a flowchart of payment processing at the time a customer gets off a taxi after getting on the taxi in an embodiment in which the card-less payment system is incorporated in a wireless taxi dispatch application.

FIG. 6 is a flowchart of payment processing at the time a customer gets off a taxi in the embodiment in which the customer got on the taxi without using the wireless taxi dispatch.

FIG. 7 is a diagram showing customer data registration contents in the above embodiment when the customer uses the dispatch application but does not use card payment.

FIG. 8 is a diagram showing customer data registration contents in the above embodiment when the customer uses the dispatch application and card payment.

FIG. 9 is a view showing an input screen of a business terminal which is used when split payment are done in a payment request in the above embodiment.

### DETAILED DESCRIPTION OF THE INVENTION

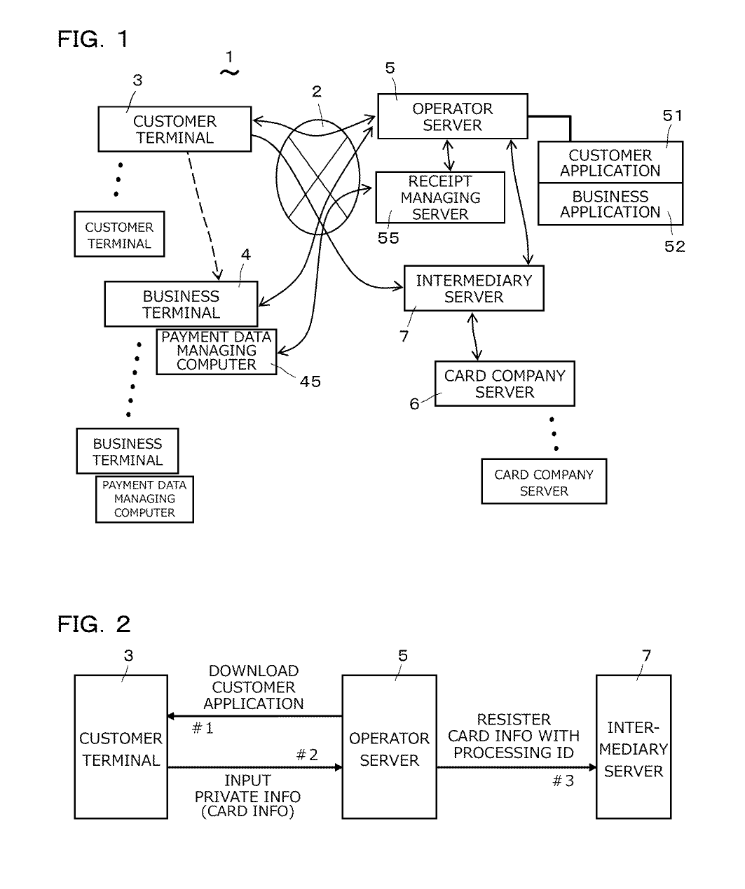

Hereinafter, a card-less payment system for various types of multiple business persons according to an embodiment of the present invention is described with reference to drawings. In FIG. 1, the card-less payment system 1 (the system) comprises a plurality of customer terminals 3 owned by customers, business terminals 4 used for card payment processing by a plurality of business persons (e.g. a personal taxi driver) of various types, an operator server 5 for operating and managing the card payment processing, card company servers 6, and an intermediary server 7. At least the customer terminals 3, the business terminals 4, the operator server 5, and the intermediary server 7 are connectable to the network 2 such as the Internet. Operators that may operate the present system are of various industries, in which there are not only taxi business, but also, goods selling businesses, for example, delivering and selling pizza and the like. The business person can receive the payment on delivery of goods through the card-less payment processing by previously joining the system provided by the operator.

The operator server 5 has a customer application 51 and a business application 52. A business person, who wishes to perform the card-less payment processing in this system, joins the service of the operator and downloads the business application 52 from the operator server 5 to the business terminal 4. The customer who wishes to receive the card-less payment processing in this system accesses a site of the operator server 5 and downloads the customer application 51 from the site to the customer terminal 3. A mobile phone, a smart phone, etc. may be used for the customer terminal 3, and a smart phone or a tablet may be used for the business terminal 4. In this embodiment, for example, in the case where the operator is a taxi company, the customer application 51 and the business application 52 provided from the operator server 5 also include an application for the wireless taxi dispatching. The business persons having their respective business terminals 4 are, for example, employees belonging to the taxi company and/or self-employed persons of individual taxis.

The card company server 6 is under umbrella of each of a plurality of card companies performing card payment processing (credit card payment processing), and the customer has previously joined one of the card companies and owns a card (however, the customer does not have to possess the card at the time of payment processing in the system). The operator shall have concluded accession to the multiple card companies. The intermediary server 7 intervenes between the customer terminal 3 and the card company server 6 and also between the operator server 5 and the card company server 6, and registers customer card information and a card processing ID (customer ID) generated to link with the customer card information, wherein those are received from the operator server 5. When information with the card processing ID, which have been transmitted by the operator server 5 to the customer terminal 3 and then transmitted by the customer terminal 3, are received by the intermediary server 7, the intermediary server 7 transmits the customer card information, linked with the card processing ID, to the card company server 6.

In the present embodiment, the business person has a payment data managing computer 45 associated with the business terminal 4 for managing payment data after completion of approval. The operator has a receipt managing server 55 associated with the operator server 5 for carrying out receipt management after completion of approval from the card company server 6. The business terminal 4 itself may have the function of the payment data managing computer 45, and the operator server 5 itself may have the function of the receipt managing server 55.

In the system, all of the programs, namely, the customer application 51 downloaded to the customer terminal 3, the business application 52 downloaded to the business terminal 4, and programs stored in the operator server 5 and the intermediary server 7, are operated, and then the card-less payment processing becomes possible. The card-less payment method by this system is achieved by the operation of such programs.

Programs for executing following processes are stored in the operator server 5:

(A) a process for making the customer application download in response to access from the customer terminal 3 and a process for registering the customer card information by adding the card processing ID in the intermediary server 7 wherein the registering is performed when customer personal information and customer card information entered from the customer terminal 3 are received;

(B) a process for receiving a payment request by receiving the payment amount and the telephone number of the customer terminal 3 entered from the business terminal 4 when a customer having the customer terminal 3 wants to pay using the customer application for the cost of the goods or services provided by the business person having the business terminal 4 in which the business application is installed;

(C) a process for transmitting approval information including the card processing ID and the payment amount to the customer terminal 3 upon receiving the payment request from the business terminal 4; and

(D) a process for transmitting a payment result notified from the intermediary server 7 to the business terminal 4 and the customer terminal 3.

Programs for executing the following processes are stored in the intermediary server 7:

(E) a process for receiving a payment request by receiving the card processing ID and the payment amount transmitted from the customer terminal 3 when it is judged by the customer that there is no mistake in the approval information from the operator server 5; and

(F) processes, which are performed when the payment request is received from the customer terminal, for making a payment request to the card company server 6 after replacing the card processing ID with the customer card information, receiving the payment result sent from the card company server 6, and notifying the payment result to the operator server 5.

Next, operation of the system configured as described above is described. FIG. 2 shows operations done by each of the customer terminal 3 acquiring the customer application, the operator server 5, and the intermediary server 7. The customer application 51 is downloaded to the customer terminal 3 from the operator server 5 by the operation of the customer (#1). When the customer personal information (including the telephone number) and the card information are entered into the customer terminal 3 and transmitted to the operator server 5 (#2), the operator server 5 adds the card processing ID to the customer card information and registers them in the intermediary server 7 (#3). The operator server 5 stores the customer personal information linked to the card processing ID.

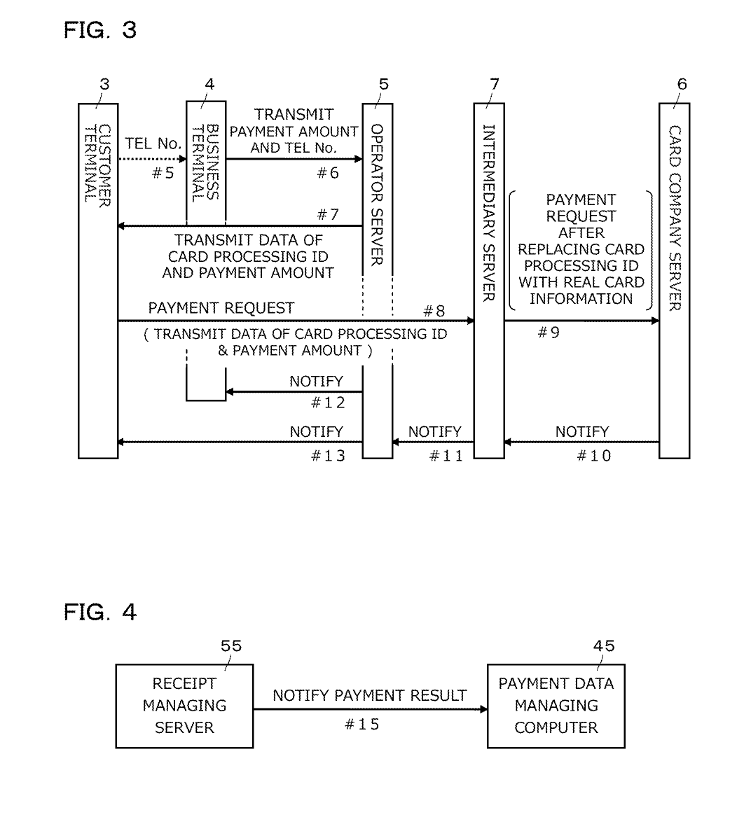

FIG. 3 shows the operation of the card payment processing in the system. In the description, it is supposed that the business application 52 is downloaded in the business terminal 4 and the customer application 51 is downloaded in the customer terminal 3, in advance from the operator server 5. When the customer having the customer terminal 3 wants to perform card payment using the customer application 51 for cost of the goods or services provided by the business person, the business person enters the payment amount and the telephone number of the customer terminal 3 into the business terminal 4 using the business application 52 (#5). A payment request is made by transmitting those entered to the operator server 5 (#6). The operator server 5 transmits approval information including a card processing ID and the payment amount to the customer terminal 3 in response to the payment request from the business terminal 4 (#7). The entering of the telephone number is carried out by the business person by asking the customer the telephone number and inputting to the business terminal 4.

The customer confirms the approval information transmitted from the operator server 5, displayed on the customer terminal 3, and when it is judged that there is no mistake, a payment request is made by transmitting the card processing ID and the payment amount from the customer terminal 3 to the intermediary server 7 (#8). Upon receipt of the payment request, the intermediary server 7 replaces the card processing ID with the card information and makes a payment request to the card company server 6 (#9). The card company server 6 judges whether or not the payment request is valid and notifies the intermediary server 7 of a payment result (#10). The intermediary server 7 notifies the operator server 5 of the payment result received via the notification (#11). The operator server 5 notifies the business operator terminal 4 and the customer terminal 3 of the payment result received via the notification (#12, #13).

FIG. 4 shows a card payment notification process in the system. Upon receiving the card payment result notification as described above, the operator server 5 hands over approval completion data to the receipt managing server 55 under the control of the operator and stores it therein. As a result, the operator can conduct receipt management. Furthermore, the receipt managing server 55 notifies the payment data after completion of the approval to the payment data managing computer 45 under the control of the business person (#15). As a result, the business person can manage the payment data.

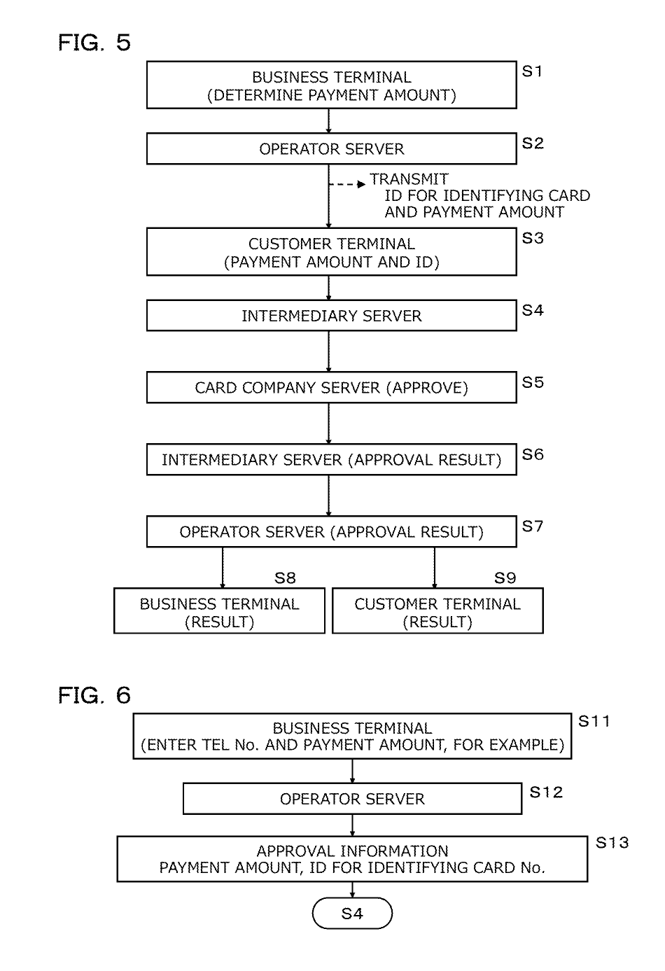

FIG. 5 to FIG. 9 show processing procedures and the like in an embodiment in which the present card-less payment system is incorporated in a wireless taxi dispatch system (dispatch application). FIG. 5 shows the procedure of payment processing at the time a customer gets off a taxi after getting on the taxi that is dispatched wirelessly. To use the dispatch application, the customer terminal 3 and the business terminal 4 are each equipped with a GPS for acquiring respective position information, and the wireless taxi dispatch is done so that, when a customer requests taxi dispatch to the operator server 5 using the customer terminal 3, a taxi relatively close to the place where the customer is located is dispatched using the GPS function of the business terminal 4 and the customer terminal 3. The customer information of the customer terminal 3 is notified to the business terminal 4 of the dispatched taxi from the operator server 5.

The customer gets on the taxi requested and dispatched, and at the time of getting off at the destination, the business person (ie, a taxi driver) determines the payment amount with the business terminal 4 (S1) and transmits it to the operator server 5 (S2; corresponding to #6 in FIG. 3). Here, the card processing ID and the payment amount are transmitted. Then, the payment amount and the card processing ID are transmitted from the operator server 5 to the customer terminal 3 (S3; corresponding to #7 in FIG. 3). If they are approved by the customer, a payment request is transmitted to the intermediary server 5 (S4; corresponding to #8 in FIG. 3), and then a payment request is transmitted to the card company server 6 (S5; corresponding to #9 in FIG. 3), and if it is approved an approval result is transmitted to the intermediary server 7 (S6; corresponding to #10 in FIG. 3). Further, the approval result is transmitted from the intermediary server 7 to the operator server 5 (S7; corresponding to #11 in FIG. 3), and a payment result is transmitted from the operator server 5 to the business terminal 4 and the customer terminal 3 (S8, S9; corresponding to #12, #13 in FIG. 3).

FIG. 6 shows payment processing when a customer gets off a taxi who got on the taxi without using the wireless dispatch. In this case, information on the customer is not stored in advance in the business terminal 4 of the taxi driver. In such a case, when the customer wants to perform the card-less payment using the customer terminal 3, the taxi driver asks the customer (passenger) the telephone number of the customer terminal 3, enters the telephone number and the payment amount into the business terminal 4 (S11) and transmits them to the operator server 5 (S12). Then, if the customer can be identified in the operator server 5 by using the telephone number as a key, approval information including the card processing ID and the payment amount is transmitted to the customer terminal 3 (S13). Thereafter, the same processing as that in S4 (FIG. 5) is performed. Instead of the telephone number, QR code may be used. According to the above processing, it is possible to quickly and easily perform payment at the time of getting off in the case that the customer got on a taxi without using the wireless dispatch. Also, taxi operators who do not have a wireless dispatch system can perform the card-less payment quickly and easily.

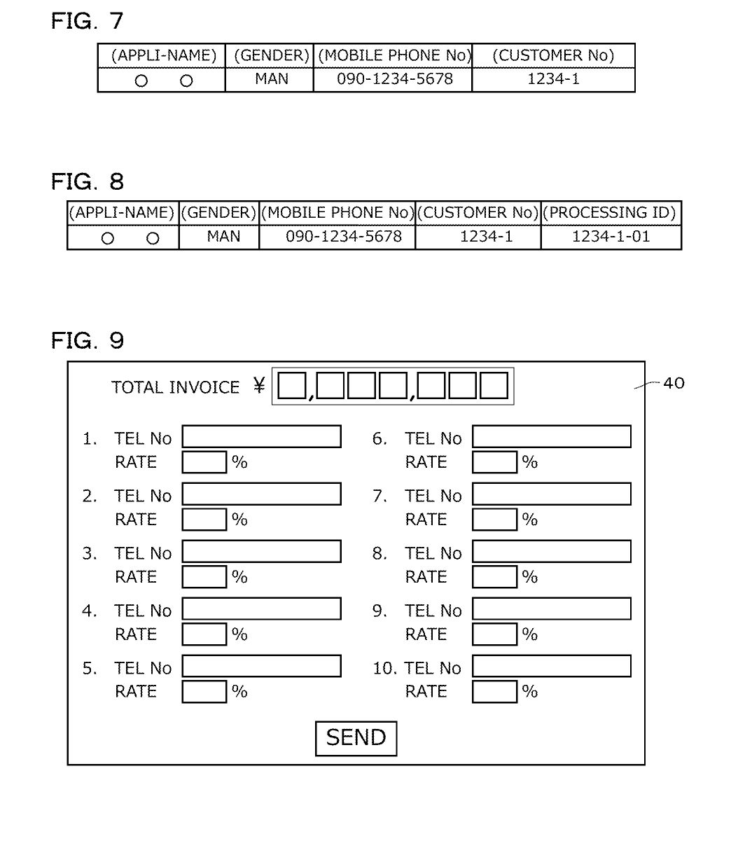

FIG. 7 shows customer data registration contents using a dispatch application, but not using the card-less (card) payment, for reference. The customer accesses the site of the dispatch application of the operator server 5 (dispatch server), downloads the dispatch application, and enters predetermined items. The entering items include (1) dispatch application name, (2) mobile telephone number, and (3) gender. By entering the items, a customer number for car-dispatch identification is automatically given by the operator server 5.

FIG. 8 shows customer data registration contents in the case when the card-less (card) payment and the dispatch application are used. In the input items, in addition to the above, (4) payment card number, (5) card expiration date, and (6) card holder name are included. The above (4), (5) and (6) are registered and input with the dispatch application, but the registration destination is the intermediary server 7 for card payment registration. By entering the above, the operator server 5 automatically issues a card processing ID which works instead of the real card information, in addition to the customer number for car-dispatch identification, and the card processing ID is held also by the intermediary server 7. Thus, since the information communicated between the customer terminal 3, the business terminal 4, and the operator server 5 during the payment processing operation in the present system does not include the real card information and the card processing ID is used, the security of the real card information is enhanced.

In the embodiment, in which the system uses the dispatch application for performing the card-less payment described above, each server or the like can have the following functions. The operator server 5 (dispatch server) manages the dispatch application and enables the following matters. (1) car dispatch work by acquiring position information of moving business terminal 4, (2) management of dispatch record, (3) management of bill for dispatch commission, (4) management of customer information including the card processing ID, (5) management of card processing performance.

The business terminal 4 is equipped with a dispatch application for mobile station (including card-less payment) or a simple management card processing application for mobile station (no dispatch function), as the business application 52. The dispatch application for mobile station transmits the position information to the operator server 5 (dispatch server), communicates with the customer terminal 3 to enable the dispatch work, and enables the card-less payment processing. The simple management card processing application for mobile station can not perform the dispatching work described above, but enables the card-less payment processing.

With respect to the intermediary server 7, since the information of the input items (4), (5) and (6) are important personal information, they are not managed by the operator and the like themselves from the security point of view, and therefore the intermediary server 7 is requested to manage them as a specialist of credit card settlement. The information of the input items (4), (5) and (6) are registered temporarily in the dispatch server, and the card processing ID given to the information is held by the dispatch server. When the intermediary server 7 obtains the card processing ID and the information on the payment amount from the dispatch server, the intermediary server 7 replaces the card processing ID with the actual information and makes a payment request to each card company.

The card company server 6 makes an approval decision on the information received from the intermediary server 7, and then notifies the intermediary server 7 of the result. The payment data managing computer 45 receives and manages data of the business person (mobile station) who made the card settlement, amounts, total amounts, and the like.

In an embodiment of the present system, in a case that the business terminal 4 and the customer terminal 3 are transmitting GPS position information, when a payment request is made from the business terminal 4, the operator server 5 refers to each GPS position information of both the business terminal 4 and the customer terminal 3, and transmits approval information to the customer terminal 3 (corresponding to #7 of FIG. 3) only when it is determined that both terminals are within a predetermined distance range (for example, 5 to 10 m). When they are not within the predetermined distance range, an error-handling routine is performed because there is something wrong in the business terminal 4 and the customer terminal 3. Thereby, security can be enhanced.

FIG. 9 shows an input screen 40 of the business terminal 4 according to an embodiment enabling split payment in the payment request in this system. At the time of payment, the business person enters the charged amount in the total invoice amount field of the input screen 40, furthermore, asks the telephone number of each customer terminal 3 of the customers who wants to pay for splitting, and enters the numbers in the telephone number entry fields 1 to 10, and inputs the split percentage rate in the percentage entry fields. Then, the split payment amount for each customer terminal 3 is automatically calculated by the business terminal 4 and displayed. When the business person taps the send button, the data is transmitted to the operator server 5. Thereafter, an approval screen is transmitted from the operator server 5 to each customer terminal 3, and then each customer confirms it and transmits a payment request. In this way, the split payment can be done easily.

As described above, the present system is a payment system provided by a operator, each of different business persons can become a member of the system, and it can be used for payment of goods price sold at stores in addition to the taxi business. The customer can make a credit card payment easily without possessing the credit card at the time of purchase of goods, only by registering own credit card information in advance in the customer application, wherein the application is for a card payment processing application adopted by various types of business persons who are affiliated with the application service. Since a network is constructed by various types of multiple business persons affiliated with the application services, respectively, by once registering in the application for the card payment processing with which one business person is affiliated, even if payment is going to be made for goods purchased at a store of other business person who is affiliated with other application service, the customer can make easy and quick payment with cash-less and card-less. Therefore, unauthorized use of the card is prevented and security is enhanced. Also, because it is a credit card payment, it is postpaid rather than prepaid, which is convenient for customers.

Even for the business persons, since it is possible to shorten the useless time required for conventional card payment by merely affiliating with the application service of the card payment processing, and the card processing can be performed using a tablet or the like, in particular, a lot of money is necessary when a card processing equipment is installed on a mobile station but that is no longer necessary. Note that the present invention is not limited to the configuration of the above embodiment, and various modifications are possible. For example, in the above description, although the customer is authenticated by asking about and inputting the telephone number of the customer terminal at the time of payment in the case of getting on a car other than wireless dispatch, QR code (registered trademark) may be used instead of the telephone number. In such a case, the QR code (registered trademark) for the customer is transmitted to the customer terminal 3 from the operator server 5 beforehand, and the QR code (registered trademark) displayed on the customer terminal 3 is read by the business terminal 4.
1 Card-less payment system (this system)
2 Network
3 Customer terminal
4 Business terminal
5 Operator server
51 Customer application
52 Business application
6 Card company server
7 Intermediary server

1. A card-less payment system, comprising:
a customer terminal owned by a customer and connectable to a network;
a business terminal used for card payment processing by a business person of various types and connectable to the network;
an operator server for operating and managing the system with a business application and a customer application which are used for the card payment processing by the business person and the customer, respectively;
a card company server for performing the card payment processing; and
a intermediary server for performing processing between the customer terminal and the card company server and also between the operator server and the card company server, wherein
the customer application is in advance downloaded from the operator server to the customer terminal and, when customer card information is entered into the customer terminal and transmitted to the operator server, the operator server adds a card processing ID to the customer card information and registers them in the intermediary server,
the business application is in advance downloaded from the operator server to the business terminal and,
when the customer having the customer terminal wants to perform card payment using the customer application for cost of the goods or services provided by the business person, a payment request is made by the business person by entering payment amount and telephone number of the customer terminal into the business terminal and transmitting them to the operator server using the business application,
the operator server transmits approval information including the card processing ID and the payment amount to the customer terminal in response to the payment request from the business terminal,
when it is judged by the customer that there is no mistake in the approval information transmitted from the operator server, a payment request is made by the customer by transmitting the card processing ID and the payment amount from the customer terminal to the intermediary server,
the intermediary server, upon receiving the payment request from the customer terminal, makes a payment request to the card company server after replacing the card processing ID with the customer card information, receives a payment result transmitted from the card company server, and notifies the payment result to the operator server,
the operator server transmits the notified payment result to the business terminal and the customer terminal.

2. The card-less payment system according to claim 1, wherein
the operator server refers to location information of each GPS of the business terminal and the customer terminal at the time of receiving the payment request from the business terminal, and only when it is found that the two terminals are within predetermined distance range, transmits the approval information to the customer terminal.

3. The card-less payment system according to claim 1, wherein
the business terminal is possessed by a taxi driver or mounted on a taxi, and the operator server is a server for managing dispatch of a taxi.

4. A program for a card-less payment system, wherein
the card-less payment system comprises:
a customer terminal owned by a customer and connectable to a network;
a business terminal used for card payment processing by a business person of various types and connectable to the network;
an operator server for operating and managing the system with a business application and a customer application which are used for the card payment processing by the business person and the customer, respectively;
a card company server for performing the card payment processing; and
a intermediary server for performing processing between the customer terminal and the card company server and also between the operator server and the card company server, wherein
the program is operative so that:
the operator server makes the customer application downloadable when the customer terminal accesses to the operator server, adds a card processing ID to customer card information, and registers them in the intermediary server when the customer card information is entered into the customer terminal and transmitted to and received by the operator server;
the operator server receives a payment request by receiving payment amount and telephone number of the customer terminal transmitted from the business terminal when the customer having the customer terminal wants to perform card payment using the customer application for cost of the goods or services provided by the business person having the business terminal in which the business application is installed;
the operator server transmits approval information including the card processing ID and the payment amount to the customer terminal after receiving the payment request from the business terminal;
the operator server transmits a payment result to the business terminal and the customer terminal after the payment result is notified to the operator server by the intermediary server;
the intermediary server receives a payment request by receiving the card processing ID and the payment amount transmitted from the customer terminal by the customer after judging that there is no mistake in the approval information transmitted from the operator server; and
the intermediary server, upon receiving the payment request from the customer terminal, makes a payment request to the card company server after replacing the card processing ID with the customer card information, receives a payment result transmitted from the card company server, and notifies the operator server of the payment result.

5. A card-less payment method, using:
a customer terminal owned by a customer and connectable to a network;
a business terminal used for card payment processing by a business person of various types and connectable to the network;
an operator server for operating and managing with a business application and a customer application which are used for the card payment processing by the business person and the customer, respectively;
a card company server for performing the card payment processing; and
a intermediary server for performing processing between the customer terminal and the card company server and also between the operator server and the card company server, wherein
the operator server performs steps of:
making the customer application downloadable when the customer terminal accesses to the operator server, adding a card processing ID to customer card information and registering them in the intermediary server when the customer card information is entered into the customer terminal and transmitted to and received by the operator server;
receiving a payment request by receiving payment amount and telephone number of the customer terminal transmitted from the business terminal when the customer having the customer terminal wants to perform card payment using the customer application for cost of the goods or services provided by the business person having the business terminal in which the business application is installed;
transmitting approval information including the card processing ID and the payment amount to the customer terminal after receiving the payment request from the business terminal; and
transmitting a payment result to the business terminal and the customer terminal after the payment result is notified to the operator server by the intermediary server, and
the intermediary server performs steps of:
receiving a payment request by receiving the card processing ID and the payment amount transmitted from the customer terminal by the customer after judging that there is no mistake in the approval information transmitted from the operator server; and
upon receiving the payment request from the customer terminal, making a payment request to the card company server after replacing the card processing ID with the customer card information, receiving a payment result transmitted from the card company server, and notifying the settlement result to the operator server.

6. The card-less payment system according to claim 2, wherein
the business terminal is possessed by a taxi driver or mounted on a taxi, and the operator server is a server for managing dispatch of a taxi.
